(19) United States
(12) Patent Application Publication
(10) Pub. No.: US 2010/0156888 A1
(43) Pub. Date: Jun. 24, 2010

(54) Adaptive mapping for heterogeneous processing systems

(75) Inventors: Chi-Keung Luk, Ashland, MA (US); Paul Geoffrey Lowney, Concord, MA (US)

Correspondence Address: INTEL CORPORATION;c/o CPA Global, P.O. BOX 52050, MINNEAPOLIS, MN, 55402, US

(73) Assignee: Intel Corporation

(21) Appl. No.: 12/317,450

(22) Filed: Dec. 23, 2008

(51) Int. Cl. G06T 1/00

(52) U.S. Cl. 345/418

(57) ABSTRACT

Embodiments of a system, program product and method are presented to perform automatic partitioning of work between host processor (such as, e.g., a CPU) and at least one additional heterogeneous processing element (such as, e.g., a GPU) through run-time adaptive mapping. The adaptive mapping may be performed by a dynamic compiler, based on projected execution times predicted by curve fitting based on actual execution times generated during a profile run of the program. Other embodiments are described and claimed.

### BACKGROUND

Heterogeneous multiprocessors are increasingly important in the multi-core era due to their potential for high performance and energy efficiency. That is, to improve performance and efficiency, some multi-core processing systems are transitioning from homogenous cores to heterogeneous systems with multiple, but different, processing elements. These heterogeneous systems may include one or more general purpose central processing units (CPUs) (one of which is referred to herein as a “host”) as well as one or more of the following additional processing elements: specialized accelerators, graphics processing unit(s) (“GPUs”) and/or reconfigurable logic element(s) (such as field programmable gate arrays, or FPGAs). As used herein, a “processing element” is a generic term that refers to a processor, GPU, or other hardware element capable of executing one or more stream(s) of instructions.

While these machines provide large computation bandwidth, the job of programming these machines can be very challenging for two reasons. First, the host processor and the additional processing elements on these architectures typically have separate address spaces (for both code as well as data). As a result, extra and often tedious programming effort is required to coordinate the control and data flows between the host and the additional element, just to ensure correctness. Second, significant effort is required to map a given computation to the underlying hardware in order to achieve performance goals. This is particularly challenging if a given computation can run on either/both the host processor and the additional element.

The prevailing approach used in today's heterogeneous systems is to put the burden on the programmer—only very basic programming supports are provided to orchestrate programming of the heterogeneous system. To utilize these heterogeneous systems, it is often required that the programmer manually and statically define which portions of a program are to be executed on the additional elements rather than on the host. Such programmer definition may be accomplished, for example, via a pragma statement or other compiler directive. This approach may be unduly burdensome for all but the most expert programmers. Furthermore, this static mapping approach is not only labor intensive but also fails to provide the flexibility to adapt the mapping based on changes in runtime environments. The optimal mapping is likely to change with different applications, different input problem sizes, and different hardware configurations.

### BRIEF DESCRIPTION OF THE DRAWINGS

FIG. 1 is a block diagram of at least one embodiment of a system to perform run-time adaptive mapping.

FIG. 2 is a block diagram showing further detail of at least one embodiment of a system to perform run-time adaptive mapping.

FIG. 3 illustrates a pseudocode example of the use a stream-API programming approach.

FIG. 4 illustrates a pseudocode example of the use of a threading-API programming approach.

FIG. 5 is a block diagram of a system in accordance with at least one embodiment of the present invention.

FIG. 6 is a block diagram of a system in accordance with at least one other embodiment of the present invention.

FIG. 7 is a block diagram of a system in accordance with at least one other embodiment of the present invention.

FIG. 8 is a flowchart illustrating at least one embodiment of a method for dynamically compiling code to run concurrently on heterogeneous processing elements.

FIG. 9 is a flowchart illustrating at least one embodiment of an adaptive mapping method that may be employed by a dynamic compiler.

### DETAILED DESCRIPTION

Embodiments discussed herein accurately and in real time perform adaptive mapping. The mapping is performed automatically, rather than manually, to decide the mapping from computations specified in a user program to heterogeneous processing elements using run-time adaptation.

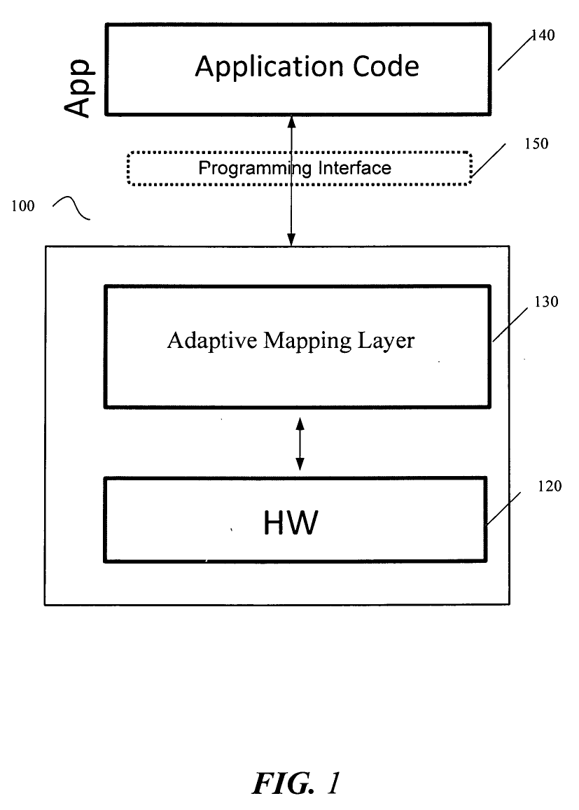

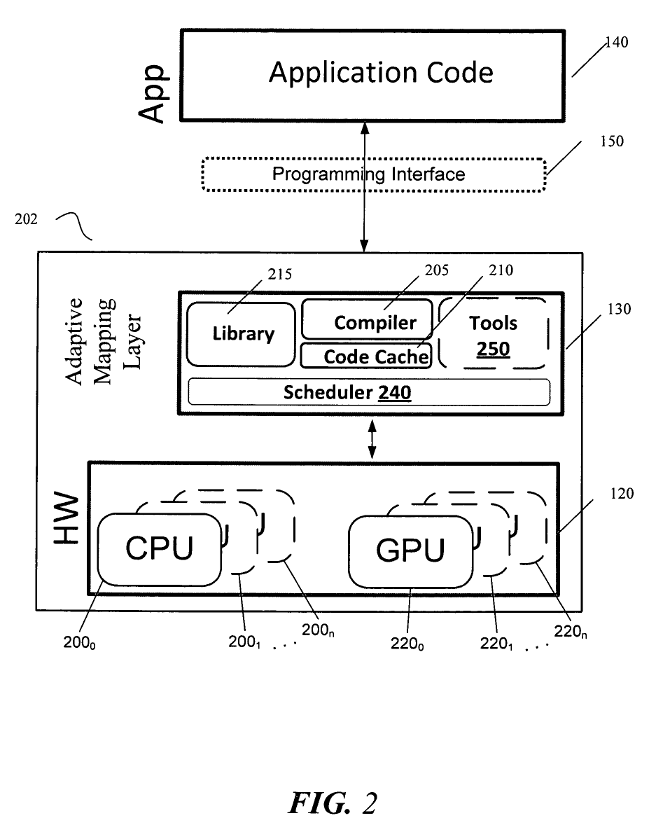

FIG. 1 illustrates at least one embodiment of an adaptive mapping system 100. FIG. 1 illustrates that the system 100 includes hardware elements 120 and also includes additional elements that are referred to herein as an adaptive mapping layer 130. The adaptive mapping layer 130 may include software elements as explained below in connection with FIG. 2.

FIG. 1 illustrates that at least one embodiment of the system 100 is to interact with a software application 140. The software application 140 may include one or more code instructions that conform to a programming interface 150.

For at least one embodiment, the programming interface 150 is an application programming interface (referred to herein as an “API”). The API provides an interface via which a programmer may indicate potentially parallelizable operations. Allowing the programmer to explicitly express such computations through the API relieves the compiler from the difficult job of extracting parallelism from serial code. The compiler instead can focus on one or more performance optimizations.

For at least one embodiment, the API 150 may be implemented as an extension to a known high-level programming language, such as C++. Unlike other known API's, the API 150 illustrated in FIG. 1 works in conjunction with the adaptive mapping layer 130 to exploit the concurrent hardware parallelism available on different types of heterogeneous hardware components of the system hardware 120. (For example, for an embodiment such as that illustrated in FIG. 2, below, the parallelism of both the CPU and GPU may be exploited during run-time based on programmer use of API 150 instructions). The API 150 may combine one or more features of a current threading API for CPU processors (such as, e.g., Intel® Threading Building Blocks (Intel® TBB)) with one or more features of a current threading API for GPUs (such as, e.g., NVIDIA CUDA™ API).

However, in addition to combining API features for several different heterogeneous hardware architecture types, the API 150 also defines new data types and new functions to facilitate adaptive mapping.

For at least one embodiment, the API 150 defines two new data types: an array type and a an array list type (referred to herein as QArray and QArrayList, respectively). While embodiments of the new data types may be defined using C++ templates, they may be based on other languages in other embodiments. A data structure of the new array type (e.g., QArray) represents a multidimensional array of a generic type. For example, QArray<float> is the type for an array of floating point elements. QArray may be an opaque type and its actual implementation may be hidden from the programmer.

A data structure of the new array list type (e.g., QArrayList) represents a list of objects of the new array type (e.g., QArray), and may also an opaque type.

While the API 150 allows the programmer to express potentially parallelizable operations in the application code 140, the actual work of parallelizing the computations is performed by the adaptive mapping layer 130. The work of the adaptive mapping layer 130 to efficiently and dynamically map work of the application code 140 among the heterogeneous processing elements of the hardware 120 may be performed on either of the two new data types (i.e., QArray array type or QArrayList list of array type).

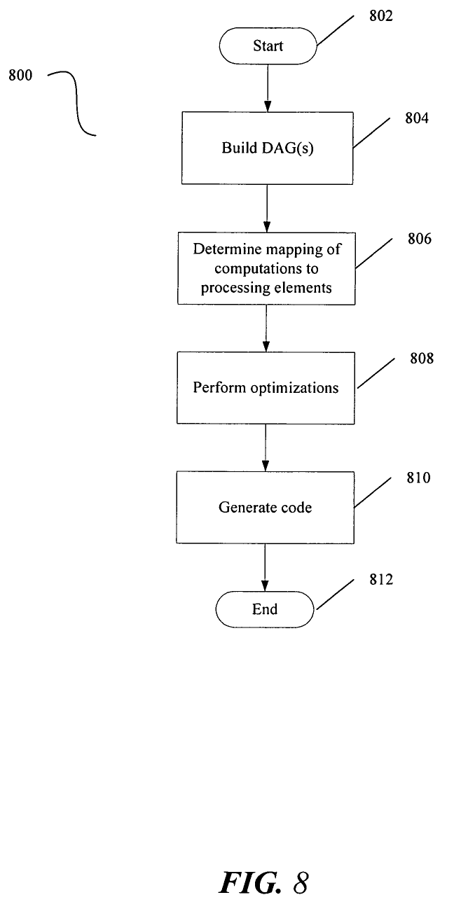

A programmer may utilize the API 150 in any of several manners. A first approach, referred to herein as the stream approach, is to solely use API 150 calls that implement common data-parallel operations including elementwise, reduction, and linear algebra operations on objects of QArray type. These functions of the API 150 are similar to those found in some GPGPU systems. However, since the adaptive mapping layer 130 targets heterogeneous machines, the stream function calls of API 150 also allow the programmer to optionally select the processing element type. To do so, the programmer may utilize mapping directives that are to be processed by the compiler as described below in connection with block 806 of FIG. 8. For instance, “QArray<float> Qsum=Add(Qx, Qy, PE_SELECTOR_GPU)” specifies that the addition of the two arrays Qx and Qy must be performed on a GPU. Another possible sample mapping directive value is PE_SELECTOR_CPU for choosing a CPU. Also, another possible sample mapping directive value is PE_SELECTOR_DEFAULT, which may be used by the programmer to choose the default mapping scheme so that the compiler will select the appropriate mapping according to the default mapping scheme. The default mapping scheme may be, for example, a static mapping scheme or, in the alternative, may be an embodiment of the adaptive mapping scheme discussed below in connection with FIG. 8. Although specific mapping directive values have been set forth herein (e.g., PE_SELECTOR_GPU, PE_SELECTOR_CPU, and PE_SELECTOR_DEFAULT), such examples should not be taken to be limiting. One of skill in the art will recognize that additional or different names may be used.

FIG. 2 illustrates some further details for at least one embodiment of a system 202 such as that 100 illustrated in FIG. 1. FIG. 2 illustrates that hardware system 120 may include multiple processing elements. The processing elements of the target hardware system 120 may include one or more general purpose processing units 200₀ such as, e.g., central processing units (“CPUs”). For embodiments that optionally include multiple general purpose processing units 200, additional such units (200₁-200ₙ) are denoted in FIG. 2 with broken lines.

The general purpose processors 200₀-200ₙ of the target hardware system 120 may include multiple homogenous processors having the same instruction set architecture (ISA) and functionality. Each of the processors 200 may include one or more general-purpose processor cores. Indeed, for at least one embodiment the target hardware 120 includes a single multi-core CPU. One or more of the cores of a multi-core CPU 200 may provide short-vector parallelism provided by a SIMD (Single Instruction, Multiple Data) extension of the instruction set architecture (ISA) of the CPU 200, such as Intel® Streaming SIMD Extensions (Intel® SSE).

For at least one other embodiment, however, at least one of the CPU processing units 200₀-200ₙ may be heterogeneous with respect to one or more of the other CPU processing units 200₀-200ₙ of the target hardware system 120. For such embodiment, the processor cores 200 of the target hardware system 120 may vary from one another in terms of ISA, functionality, performance, energy efficiency, architectural design, size, footprint or other design or performance metrics. For at least one other embodiment, the processor cores 200 of the target hardware system 120 may have the same ISA but may vary from one another in other design or functionality aspects, such as cache size or clock speed.

Other processing element(s) 220 of the target hardware system 120 may feature ISAs and functionality that significantly differ from general purpose processing units 200. These other processing units 220 may optionally include multiple processor cores. For at least one embodiment, one or more of the other processing units 220 (e.g., a GPU) may include multiple special-purpose cores.

For one example embodiment, which in no way should be taken to be an exclusive or exhaustive example, the target hardware system 120 may include one or more general purpose central processing units (“CPUs”) 200₀-200ₙ along with one or more graphics processing unit(s) (“GPUs”), 220₀-220ₙ. Again, for embodiments that optionally include multiple GPUs, additional such units 220₁-220ₙ are denoted in FIG. 2 with broken lines.

As indicated above, the target hardware system 120 may include various types of additional processing elements 220 and is not limited to GPUs. Any additional processing element 220 that has characteristics of high parallel computing capabilities (such as, for example, a computation engine, a digital signal processor, acceleration co-processor, etc) may be included, in addition to the one or more CPUs 200₀-200ₙ of the target hardware system 120. For instance, at least one other example embodiment the target hardware system 120 may include one or more reconfigurable logic elements 220, such as a field programmable gate array. Other types of processing units and/or logic elements 220 may also be included for embodiments of the target hardware system 120. As is stated above, for at least one embodiment of the system 202 includes as the additional processing element 220 a multi-core GPU.

FIG. 2 further illustrates that the adaptive mapping layer 130 may include a compiler 205. For at least one embodiment, the compiler 205 is a dynamic compiler, such as a just-in-time compiler. At least one embodiment of the compiler 205 dynamically translates the API calls into native machine codes for the CPU(s) 200 and/or GPU(s) 220 as appropriate according to the dynamic mapping algorithm discussed below.

For at least one embodiment, instead of directly generating CPU and GPU native machine codes, the compiler 205 generates TBB and CUDA source codes from the application code program(s) 140 on the fly and then uses system compilers (such as, e.g., a CPU C compiler and/a GPU C compiler—not shown) to generate the final machine codes.

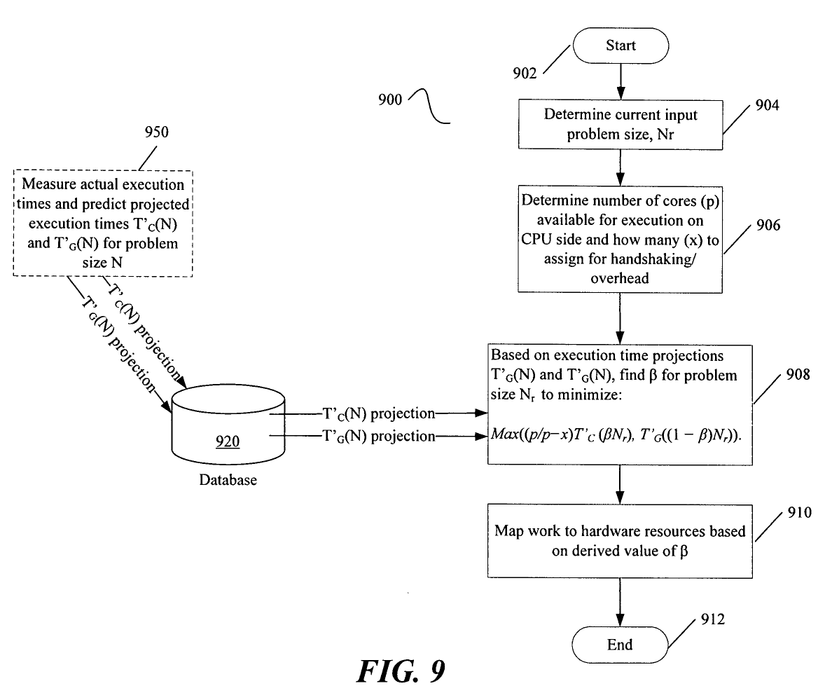

Thus, the compiler 205 decides the mapping of a computation to a Processing Element (PE), which can be either a CPU or a GPU for the embodiment illustrated in FIG. 2. This mapping feature of the compiler 205 is discussed in further detail below in connection with FIGS. 8 and 9.

For at least one embodiment, to reduce the runtime overhead, dynamic compilation is mostly done in a lazy-evaluation manner. When a program is executed, DAGs are built (i.e., see block 804 of FIG. 8) as API calls are encountered. Nevertheless, the remaining blocks (e.g., 806, 808, 810 of FIG. 8) of the compilation are not invoked until the computation results are really needed—that is, when a ToNormalArray( ) call is performed to convert from a QArray to a normal C array. Thus, dynamically dead API calls will not cause any compilation. In addition, code generated for a particular DAG may be stored in a software code cache 210 so that if the same DAG is seen again later in the same program run, blocks 806, 808, 810 need not be repeated for the DAG.

Accordingly, FIG. 2 illustrates that at least one embodiment of the system 202 includes one or more code caches 210. While the cache 210 is illustrated as conceptually part of the adaptive mapping layer 130, one of skill in the art will realize that such representation is for ease of illustration only, and should not be taken to be limiting. For at least one embodiment, the code cache 210 is a software-managed area of memory that has been allocated by the operating system for use as a code cache. To reduce compilation overhead, translated codes may be stored in the code cache 210 so that they can be reused without recompilation.

FIG. 2 illustrates that the adaptive mapping layer 130 may also include a scheduler 240. Once native machine codes are available, they are scheduled to be run on the CPU(s) 200 and/or GPU(s) 220 by the scheduler 240. For at least one embodiment, the scheduler 240 may be implemented with the TBB task scheduler to schedule all CPU threads; one or more CPU threads may be dedicated to handle handshaking with the GPU.

For at least one embodiment, the adaptive mapping layer 130 may also include one or more library routines in an adaptive mapping library 215. For at least one embodiment, the library routines are written for commonly used functions such as Fast Fourier Transforms (FFT), basic linear algebra routines for performing basic vector and matrix operations, etc. Multiple versions of one or more of these library routines may exist in the library 215. That is, at least some embodiments may provide optimized versions of library routines that are to perform the same function, but are optimized based on the target hardware (CPU 200 vs. GPU 220). For at least one embodiment, the library 215 may include wrapper calls to libraries provided by vendors of the hardware processing elements 120. Some examples, which are provided for illustrative purposes only and should not be taken to be limiting, are, e.g., Intel® Math Kernel Library (Intel® MKL) for the CPU 200 and NVIDIA's Compute Unified Basic Linear Algebra Subprograms (CUBLAS) library for the GPU.

Finally, FIG. 2 illustrates that the adaptive mapping layer 130 may also include optional tools 250. These optional tools 250 may include one or more development tools to help the programmer write code to efficiently utilize embodiments of an adaptive mapping scheme described herein. The optional tools 250 may include debugging, visualization, and/or profiling tools.

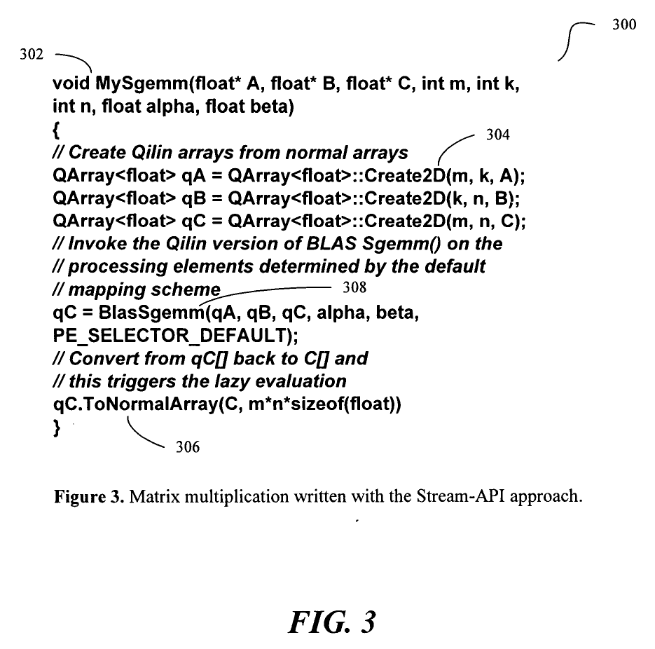

FIG. 3 illustrates a pseudocode example 300 that uses the stream approach by utilizing data types and function calls defined by the API (see, e.g., API 150 of FIGS. 1 and 2). That is, FIG. 3 illustrates an example of using unique API 150 features to perform a matrix multiplication example. FIG. 3 shows a function MySgemm( ) 302 which uses features of the API 150 to perform matrix multiplication. The function Array:: Create2D( ) 304 creates a 2D QArray from a normal C array. Its reverse is ToNormalArray( ) 306, which converts a QArray back to a normal C array. BlasSgemm( ) 308 is the BLAS Sgemm( ) function provided by the API 150. Because PE_SELECTOR_DEFAULT is used in the call, BlasSgemm( ) can be mapped by the compiler 205 to either the CPU or GPU or both, depending on the default mapping scheme.

At least one alternative embodiment allows the programmer to utilize the parallel of computation features of known threading APIs that are also supported by the API 150 (i.e., TBB on the CPU side and CUDA on the GPU side, for at least one embodiment). For such alternative embodiment(s), one or more API 150 operations are defined to “glue” together the supported API implementations to coordinate control and data flow so that they work together as the programmer specifies. When the compiler 205 compiles this glue operation 406 of the API 150, it may automatically partition computations across processing elements and eventually merge the results. Such approach is referred to herein as the threading-API approach.

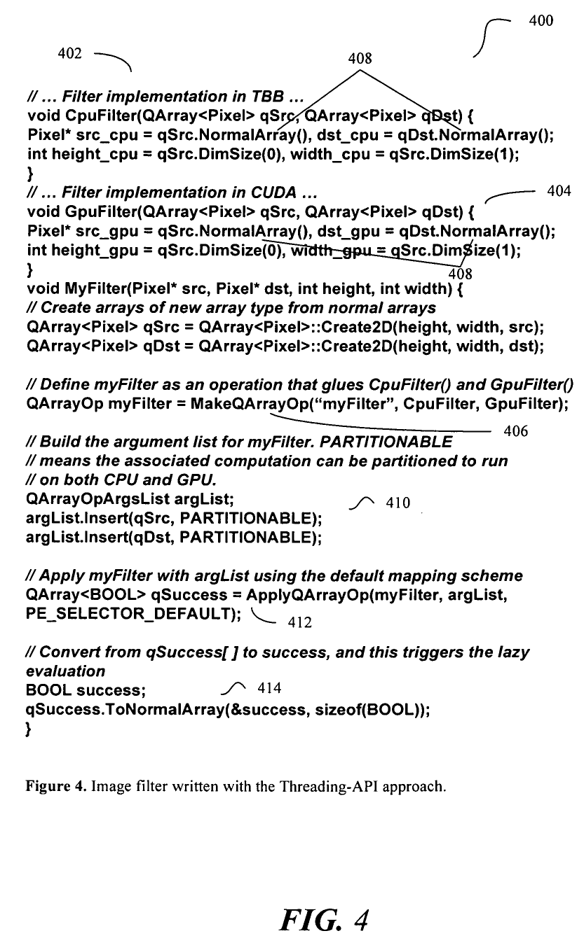

FIG. 4 illustrates a pseudocode example 400 of the use of the threading-API approach. In particular, FIG. 4 shows an example of using the threading-API approach to write an image filter. FIG. 4 illustrates a programmer-provided TBB implementation of the filter in CpuFilter( ) 402 and a programmer-provided CUDA implementation in GpuFilter( ) 404. (TBB and CUDA codes are omitted for clarity reasons). Since both TBB and CUDA work on normal arrays, new array type (e.g., QArray) arrays are converted back to normal arrays before invoking TBB and CUDA. (see 408).

FIG. 4 illustrates that a new function of the API 150, MakeQArrayOp( ) 406, is invoked to make a new operation myFilter out of CpuFilter( ) and GpuFilter( ).

FIG. 4 further illustrates that the argument list of myFilter is constructed 410 from the two new arrays qSrc and qDst. A keyword (such as, e.g., PARTITIONABLE) indicates to the adaptive mapping layer 130 that the associated computations of both arrays can be partitioned to run on the CPU and GPU.

FIG. 4 illustrates that another new function of the API 150, ApplyQArrayOp( ) 412, is called to apply myFilter with the argument list using the default mapping scheme. The result of ApplyQArrayOp( ) is a boolean array qSuccess of a single element, which returns whether the operation is applied successfully.

Finally, FIG. 4 illustrates that qSuccess is converted 414 to a normal Boolean value.

Turning now to FIG. 8, illustrated is at least one embodiment of a method 800 for dynamically compiling parallelized code to run concurrently on heterogeneous processing elements. For at least one embodiment, the method 800 may be performed by a dynamic compiler, such as that 205 illustrated in FIG. 2. FIG. 8 illustrates that the method 800 begins at block 802 and proceeds to block 804.

At block 804, one or more directed acyclic graphs (“DAGs”) are built according to the data dependencies among QArrays in the API calls of the application program (see, e.g., API 150 and application code 140 of FIGS. 1 and 2). These DAGs are effectively an intermediate representation upon which the compiler operates to achieve adaptive mapping.

From block 804, processing proceeds to block 806. At block 806, the mapping is performed. Here, the compiler (e.g., 205 of FIG. 2) may perform an embodiment of adaptive mapping as is described below in connection with FIG. 9. Alternatively, at block 806 the compiler may use programmer-specified choices to map each operation to a processing element as is described above in the example that includes mapping directives (e.g., “PE_SELECTOR_GPU, “PE_SELECTOR_CPU”, and “PE_SELECTOR_DEFAULT”). For at least one embodiment, a combination of programmer-directed mapping and automatic adaptive mapping may be performed at block 806, for at least one embodiment. From block 806, processing proceeds to block 808.

At block 808, one or more optimizations may be performed on the DAGs that were generated at block 804. Various optimizations may be performed to generate more efficient code for execution. Many of these optimizations are well-known in the art and need not be specifically called out here. For purposes of example, the optimizations performed at block 808 may include one or more of the following: operation coalescing and/or removal of unnecessary temporary arrays. The former optimization, operation coalescing, involves grouping together operations to be performed on the same processing element into a single function. Such coalescing may reduce the overhead of scheduling individual operations on the particular processing element. The latter optimization, array removal, decreases inefficient code by removing the code for allocating/deallocating and copying of temporary arrays used in the intermediate computations of QArrays.

From block 808, processing proceeds to block 810. For at least one embodiment, at the beginning of block 810 processing, the computation-to-processing element mappings have already been decided at block 806 and optimizations have been performed on one or more DAGs at block 808. At block 810, the additional processing of ensuring that hardware resource constraints are satisfied is performed. This is because resources for some processing elements may be constrained in a way that is material to mapping. For example, at block 810 the memory resources required for operations mapped to the GPU are considered. The amount of physical memory available on some GPUs is relatively limited (e.g., less than 1 GB) and such GPUs sometimes do not have virtual memory. In such instances, the GPU may not have enough memory to perform the operations associated with a DAG. In such situations, if the compiler estimates that the GPU memory requirement of a DAG exceeds the available memory resources of the GPU, at block 810 such DAG is split into multiple smaller DAGs that comply with the resource limitations of the processing element. Such smaller DAGs may then be scheduled to execute sequentially on the processing element.

After taking resource constraints into account, if needed, then code is generated at block 810. Native machine code for each processing element is generated for the DAGs mapped to that element. Code is also generated at block 810 to combine results generated from various processing elements. Processing then ends at block 812.

FIG. 9 is a flowchart further illustrating at least one embodiment of an adaptive mapping method 900 that may be employed by a dynamic compiler (see, e.g., 205 of FIG. 2 and block 806 of FIG. 8). The method 900 may perform automatic partitioning of work between host processor (such as, e.g., a CPU) and at least one additional processing element (such as, e.g., a GPU) through run-time adaptive mapping.

FIG. 9 illustrates, generally, that the method 900 can predict the execution times of a given program on different types of processing elements and for different problem sizes. FIG. 9 illustrates a dynamic approach, which automatically adapts to different programs and different problem sizes at runtime to automatically find the near-optimal mapping from computations to processing elements for the given application, problem size, and hardware configuration. To facilitate discussion of FIG. 9, we introduce the following notations:

T_{c}(N) is the actual time to execute the given program with problem size N on the host processing element (e.g., CPU).

T_{g}(N) is the actual time to execute the given program with problem size N on the additional processing element (e.g., GPU).

These actual times may be measured during a training run (see 950).

T′_{c}(N) is the predicted time to execute the given program with problem size N on the host processing element (e.g., CPU).

T′_{g}(N) be the predicted time to execute the given program with problem size Non the additional processing element (e.g., GPU).

FIG. 9 illustrates that the method 900 utilizes projected execution times to help determine the appropriate mappings. These projected execution times are stored, for at least one embodiment in a database 920. These projected execution times may be predicted according to any of various approaches.

For at least one embodiment, for example, the projected execution times (T′_{C}(N) and T′_{G}(N)) may be predicted using an analytical performance model based on static analysis. While useful, such static analysis approach may be challenged by complex programs and by advanced CPU features such as out-of-order execution, speculation, and/or prefetching.

FIG. 9 illustrates an embodiment that instead utilizes an empirical approach for the prediction of projected execution times on both the host processor and the additional processing element. The empirical approach records actual execution times and then utilizes curve-fitting to derive a linear approximation of the predicted values.

One of skill in the art will recognize that a hybrid approach using both the empirical approach and the static analysis approach may be utilized. For example, a static analysis approach may be used for the GPU while an empirical approach may be used for the CPU.

The database 920 illustrated in FIG. 9 may maintain execution-time projections for all or a subset of programs ever executed by the heterogeneous system (see, e.g., system 100 of FIG. 1). For at least one embodiment, the first time that a program is run on the system, it is used as a training run to record actual execution times. A series of execution times are generated for sub-parts of the input problem. These may be generated during a training run as follows.

The first time that the system runs the program with problem size N, if N is sufficiently large, the compiler divides N into three parts: N_{c}, N_{g} and Nᵣ where N_{c}<<Nᵣ, N_{g}<<Nᵣ, and N=N_{c}+N_{g}+Nᵣ. The scheduler schedules the N_{c} part on the CPU and the N_{g} part on the GPU, both as profiling runs. Within the CPU part, it further divides N_{c} into m subparts N_{c,1} . . . N_{c,m} and within the GPU part N_{g} into m subparts N_{g,1} . . . N_{g,m}. The system then runs N_{c,i} on the CPU and measures the execution time t_{c,i}; similarly, it measures the execution time t_{g,i}, on the GPU, both for 1≦i≦m. When all t_{c,i}'s and t_{g,i}'s are available, The compiler uses curve fitting at block 950 to construct two polynomial functions T′_{C}(N) and T′_{G}(N) to predict the actual execution times T_{C}(N) and T_{G}(N), respectively. For at least one embodiment, the polynomial functions constructed after curve fitting of the profile runs at optional block 950 are:

$$\begin{matrix}{T}_{C} ( N ) \approx {T}_{C}^{’} ( N ) \\ = {a}_{c} + {b}_{c} * N\end{matrix}$$

$$\begin{matrix}{T}_{G} ( N ) \approx {T}_{G}^{’} ( N ) \\ {a}_{g} + {b}_{g} * N\end{matrix}$$

where a_{c}, b_{c}, a_{g} and b_{g} are constant real numbers. The optional nature of block 950 is illustrated in FIG. 9 with broken lines. As is mentioned above, alternative approaches, such as static analysis, may be used to estimate execution times for at least some embodiments.

Once the compiler computes functions T′_{C}(N) and T′_{G}(N), it is in a position to decide the optimal scheduling of work across the CPU and GPU for the same program with a different input problem size. FIG. 9 illustrates that a method 900 for mapping and scheduling the work across the CPU and GPU using these projected execution times begins at block 902 and proceeds to block 904.

At block 904, the input problem size, Nᵣ, for the current problem is determined. Processing then proceeds to block 906.

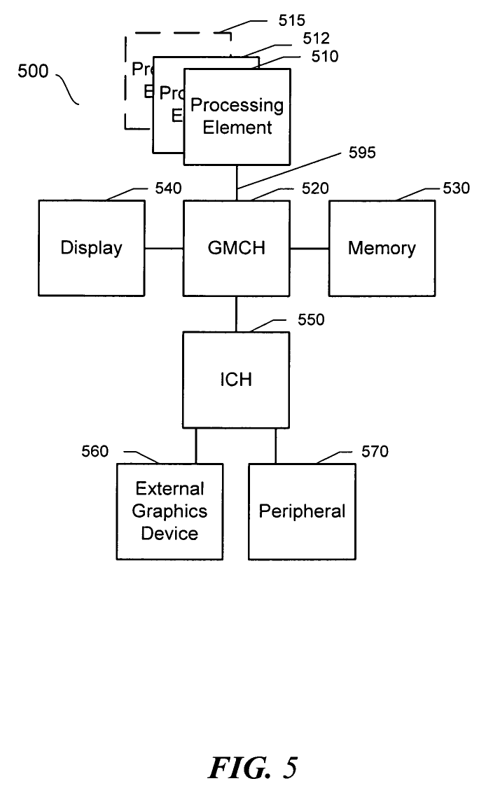

At block 906, processing related to multi-core CPUs is performed. That is, for at least some embodiments, it may be inaccurate to assume that running portions of the total input problem on each of the CPU and the GPU concurrently is a fast as running them standalone. The CPU and GPU may contend for shared resources (such as, for example, bus bandwidth and/or the need for CPU processor cycles to handshake with the GPU) while each concurrently performing their respective portions of the input problem. For at least one embodiment, the host processor is a multi-core CPU such as an embodiment of the multi-core processors discussed below in connection with FIGS. 5-7. For such embodiments, at block 906 it is determined how many (x) of the total (p) cores of the CPU should be dedicated to handshaking and other overhead activities related to execution of portions of the computation on heterogeneous processing elements. For example, on a system having an 8-core CPU and a GPU having 128 stream processors, it may be decided at block 906 to dedicate one of the CPU cores to handshake with the GPU. Processing then proceeds to block 908.

At block 908, it is determined which fraction of work of the input problem should be mapped to the CPU and which fraction should be mapped to the GPU. Let β be the fraction of work to be scheduled onto the CPU (implying that (1−β) fraction of work is scheduled on the GPU). Also, let and T(β, N) be the total execution time of this schedule for problem size N. Then

$$\begin{matrix}T ( β , N ) = Max ( {T}_{C} ( β N ) , {T}_{G} ( ( 1 - β ) N ) ) \\ \approx Max ( {T}_{C}^{’} ( β N ) , {T}_{G}^{’} ( ( 1 - β ) N ) )\end{matrix}$$

If we take into account how many (x) of the total (p) cores of the CPU should be dedicated to handshaking and other overhead activities related to execution of portions of the computation on heterogeneous processing elements, then

T(β, N)≈Max((p/p−x)T′_{C}(βN), T′_{G}((1−β)N))

If we fix N to the real problem size Nᵣ, then T′_{C}(β Nᵣ) becomes a polynomial function of a single variable β and the same for T′_{G}((1−β)Nᵣ).

At block 908 the compiler strives to find the value for β that minimizes Max(T′_{C}(βNᵣ), T′_{G}((1−β)Nᵣ). This is equivalent to finding the β value at which T′_{C}(βNᵣ) and T′_{G}((1−β)Nᵣ) intersect. There are three possible cases:
Case (i): β≦0
Case (ii): β≧1
Case (iii): 0<β<1

From block 908, processing proceeds to block 910. At block 910, the work of the input problem is mapped to the hardware resources of the heterogeneous system. For Case (i), the CPU and GPU curves interest at β≦0, where the CPU curve is represented by the function (p/p−x)T′_{C}(βNᵣ) and the GPU curve is represented by T′_{G}((1−β)Nᵣ). Thus, execution time is minimized when all work is mapped to the GPU. Accordingly, for Case (i), all work for the current input problem is mapped to the GPU at block 910.

For Case (ii), the CPU and GPU curves interest at β≧1, where the CPU curve is represented by the function (p/p−x)T′_{C}(βNᵣ) and the GPU curve is represented by T′_{G}((1−β)Nᵣ). Thus, execution time is minimized when all work is mapped to the CPU. Accordingly, for Case (ii), all work for the current input problem is mapped to the CPU at block 910.

For Case (iii), the CPU and GPU curves interest at 0<β<1, where the CPU curve is represented by the function (p/p−x)T′_{C}(βNᵣ) and the GPU curve is represented by T′_{G}((1−β)Nᵣ). Thus, execution time is minimized when mapping β of work to the CPU and (1−β) of work to the GPU. Accordingly, for Case (iii), β fraction of work is mapped on the CPU and (1−β) fraction of work on the GPU at block 910

Finally, at block 910 the performance projections are saved in the database 910. If the system sees the same computation patterns again later, it may simply use the saved projections instead of repeating the entire process.

Embodiments may be implemented in many different system types. Referring now to FIG. 5, shown is a block diagram of a system 500 in accordance with one embodiment of the present invention. As shown in FIG. 5, the system 500 may include one or more processing elements 510, 512, 515, which are coupled to graphics memory controller hub (GMCH) 520. According to at least one embodiment, the processing elements include a CPU 510 and a GPU 512. The optional nature of additional processing elements 515 is denoted in FIG. 5 with broken lines.

Each processing element may be a single core or may, alternatively, include multiple cores. The processing elements may, optionally, include other on-die elements besides processing cores, such as integrated memory controller and/or integrated I/O control logic. Also, for at least one embodiment, the core(s) of the processing elements may be multithreaded in that they may include more than one hardware thread context per core.

Additional processing element(s) 515 may include additional processors(s) that are the same as processor 510, additional processor(s) that are heterogeneous or asymmetric to processor 510, accelerators (such as, e.g., graphics accelerators or digital signal processing (DSP) units), field programmable gate arrays, or any other processing element. There can be a variety of differences between the physical resources 510, 512, 515 in terms of a spectrum of metrics of merit including architectural, microarchitectural, thermal, power consumption characteristics, and the like. These differences may effectively manifest themselves as asymmetry and heterogeneity amongst the processing elements 510, 512, 515. For at least one embodiment, the various processing elements 510, 512, and/or 515 may reside in the same die package.

FIG. 5 illustrates that the GMCH 520 may be coupled to a memory 540 that may be, for example, a dynamic random access memory (DRAM).

The GMCH 520 may be a chipset, or a portion of a chipset. The GMCH 520 may communicate with the processor(s) 510, 515 and control interaction between the processor(s) 510, 515 and memory 540. The GMCH 520 may also act as an accelerated bus interface between the processor(s) 510, 515 and other elements of the system 500. For at least one embodiment, the GMCH 520 communicates with the processor(s) 510, 515 via a multi-drop bus, such as a frontside bus (FSB) 595.

Furthermore, GMCH 520 is coupled to a display 540 (such as a flat panel display). GMCH 520 may include an integrated graphics accelerator. GMCH 520 is further coupled to an input/output (I/O) controller hub (ICH) 550, which may be used to couple various peripheral devices to system 500. Shown for example in the embodiment of FIG. 5 is an external graphics device 560, which may be a discrete graphics device coupled to ICH 550, along with another peripheral device 570.

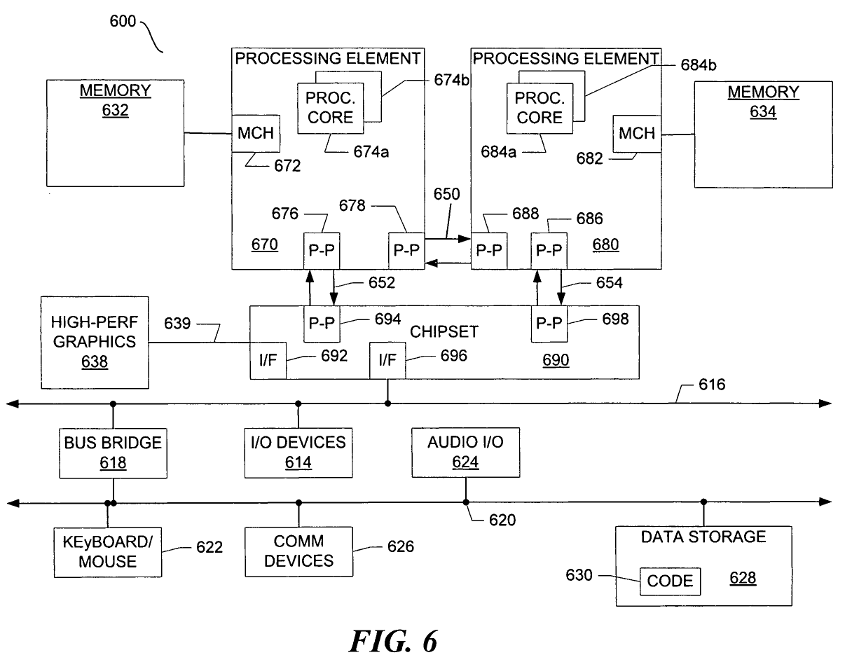

Referring now to FIG. 6, shown is a block diagram of a second system embodiment 600 in accordance with an embodiment of the present invention. As shown in FIG. 6, multiprocessor system 600 is a point-to-point interconnect system, and includes a first processing element 670 and a second heterogeneous processing element 680 coupled via a point-to-point interconnect 650. As shown in FIG. 6, one or more of processing elements 670 and 680 may be multicore processors, including first and second processor cores (i.e., processor cores 674a and 674b and processor cores 684a and 684b). One processing element 670 may be, for example, a multi-core CPU while the second processing element 680 may be, for example, a graphics processing unit. For such embodiment, the GPU 680 may include multiple stream processing cores. For other embodiments, the second processing element may be another processor, or may be an element other than a processor, such as a field programmable gate array.

While shown with only two processing elements 670, 680, it is to be understood that the scope of the present invention is not so limited. In other embodiments, one or more additional processing elements may be present in a given processor.

First processing element 670 may further include a memory controller hub (MCH) 672 and point-to-point (P-P) interfaces 676 and 678. Similarly, second processing element 680 may include a MCH 682 and P-P interfaces 686 and 688. As shown in FIG. 6, MCH's 672 and 682 couple the processors to respective memories, namely a memory 642 and a memory 644, which may be portions of main memory locally attached to the respective processors.

First processing element 670 and second processing element 680 may be coupled to a chipset 690 via P-P interconnects 676, 686 and 684, respectively. As shown in FIG. 6, chipset 690 includes P-P interfaces 694 and 698. Furthermore, chipset 690 includes an interface 692 to couple chipset 690 with a high performance graphics engine 648. In one embodiment, bus 649 may be used to couple graphics engine 648 to chipset 690. Alternately, a point-to-point interconnect 649 may couple these components.

In turn, chipset 690 may be coupled to a first bus 616 via an interface 696. In one embodiment, first bus 616 may be a Peripheral Component Interconnect (PCI) bus, or a bus such as a PCI Express bus or another third generation I/O interconnect bus, although the scope of the present invention is not so limited.

As shown in FIG. 6, various I/O devices 614 may be coupled to first bus 616, along with a bus bridge 618 which couples first bus 616 to a second bus 620. In one embodiment, second bus 620 may be a low pin count (LPC) bus. Various devices may be coupled to second bus 620 including, for example, a keyboard/mouse 622, communication devices 626 and a data storage unit 628 such as a disk drive or other mass storage device which may include code 630, in one embodiment. The code 630 may include instructions for performing embodiments of one or more of the methods described above. Further, an audio I/O 624 may be coupled to second bus 620. Note that other architectures are possible. For example, instead of the point-to-point architecture of FIG. 6, a system may implement a multi-drop bus or another such architecture.

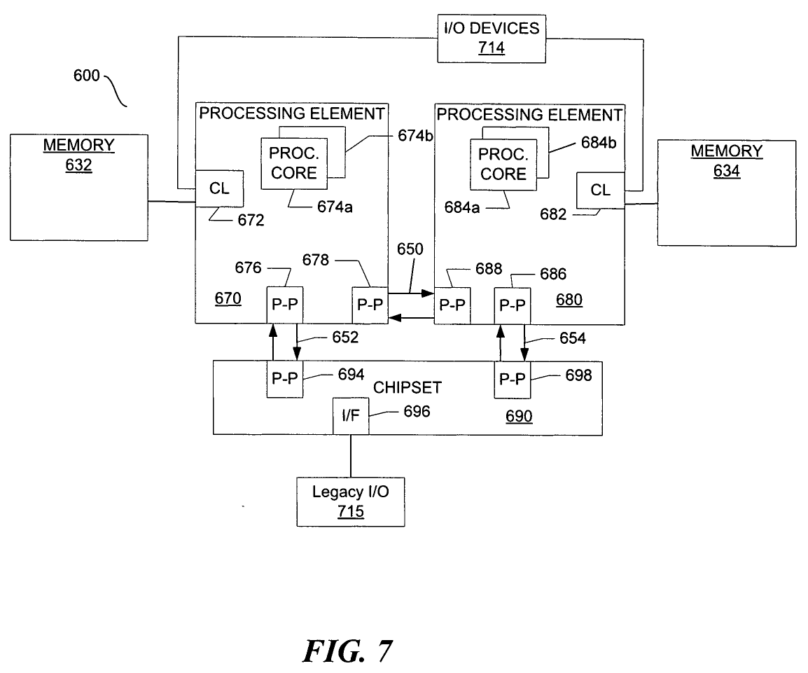

Referring now to FIG. 7, shown is a block diagram of a third system embodiment 700 in accordance with an embodiment of the present invention. Like elements in FIGS. 6 and 7 bear like reference numerals, and certain aspects of FIG. 6 have been omitted from FIG. 7 in order to avoid obscuring other aspects of FIG. 7.

FIG. 7 illustrates that the processing elements 670, 680 may include integrated memory and I/O control logic (“CL”) 672 and 682, respectively. For at least one embodiment, the CL 672, 682 may include memory controller hub logic (MCH) such as that described above in connection with FIGS. 5 and 6. In addition. CL 672, 682 may also include I/O control logic. FIG. 7 illustrates that not only are the memories 642, 644 coupled to the CL 672, 682, but also that I/O devices 714 are also coupled to the control logic 672, 682. Legacy I/O devices 715 are coupled to the chipset 690.

Embodiments of the mechanisms disclosed herein may be implemented in hardware, software, firmware, or a combination of such implementation approaches. Embodiments of the invention may be implemented as computer programs executing on programmable systems comprising at least one processor, a data storage system (including volatile and non-volatile memory and/or storage elements), at least one input device, and at least one output device.

Program code, such as code 630 illustrated in FIG. 6, may be applied to input data to perform the functions described herein and generate output information. For example, program code 630 may include a dynamic compiler that is coded to perform embodiments of the methods illustrated in FIGS. 8 and 9. Accordingly, embodiments of the invention also include media that are machine-accessible and computer usable, the media containing instructions for performing the operations of a method or containing design data, such as HDL, which defines structures, circuits, apparatuses, processors and/or system features described herein. Such embodiments may also be referred to as computer program products.

Such machine-accessible, computer-usable storage media may include, without limitation, tangible arrangements of particles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of computer-usable media suitable for storing electronic instructions.

The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The programs may be implemented in a high level procedural or object oriented programming language to communicate with a processing system. The programs may also be implemented in assembly or machine language, if desired. In fact, the mechanisms described herein are not limited in scope to any particular programming language. In any case, the language may be a compiled or interpreted language.

Presented herein are embodiments of methods, apparatuses, and systems for dynamically mapping one or more operations of an application among two or more heterogeneous processing elements. While particular embodiments of the present invention have been shown and described, it will be obvious to those skilled in the art that numerous changes, variations and modifications can be made without departing from the scope of the appended claims. Accordingly, one of skill in the art will recognize that changes and modifications can be made without departing from the present invention in its broader aspects. The appended claims are to encompass within their scope all such changes, variations, and modifications that fall within the true scope and spirit of the present invention.

What is claimed is:

1. A method comprising:
determining a mapping of work among heterogeneous processing elements during dynamic compilation of a user program;
wherein said determining is based on linear equations that approximate the time to execute a portion of said work on each processing element; and
mapping at least a portion of said work to a first of said processing elements.

2. The method of claim 1, wherein:
said linear equations have been derived from curve-fitting based on empirical run-time data.

3. The method of claim 1, further comprising:
mapping a second portion of said work to a second of said processing elements.

4. The method of claim 1, further comprising:
determining a current input problem size for said work.

5. The method of claim 1, further comprising:
determining a number of cores of said first processing element that are available for execution of said work.

6. The method of claim 1, further comprising:
determining a number of cores of said first processing element to assign for handshaking with a second of said processing elements.

7. The method of claim 1, wherein:
said determining further comprises determining, based on execution time projections T′_{G}(N) for the first processing element and T′_{G}(N) for the second processing element, a value β for problem size Nᵣ to minimize Max((p/p−x)T′_{C}(βNᵣ), T′_{G}((1−β)Nᵣ));
wherein p is a number of cores of a first of the processing elements that is available to perform portion β of said work and x is a number of cores of said first processing element that is to be reserved for handshaking with a second of said processing elements.

8. The method of claim 8, further comprising:
mapping all of said work to said first processing element responsive to determining β≦0.

9. The method of claim 8, further comprising:
mapping all of said work to said first processing element responsive to determining β≧1.

10. The method of claim 8, further comprising:
mapping a second portion of said work to a second of said processing elements responsive to determining 0<β<1.

11. A system comprising:
a die package that includes a first processing element and a second processing element, said first and second processing elements being heterogeneous with respect to each other; and
a dynamic compiler to run on said first processing element, the compiler to:
receive first and second respective projected execution times of at least a portion of a user application for said first processing element and said second processing element;
wherein said projected execution times are derived based on linear approximations constructed for empirical timing data; and
determine, during dynamic compilation of said application portion, allocation of an operation specified in said program among the first and second processing elements;
wherein said determining is based on said projected execution times, input size of said operation, and ratio of cores available on the first processing element.

12. The system of claim 11, wherein:
the second processing element is capable of concurrent execution of multiple threads.

13. The system of claim 11, wherein the first processing element is a central processing unit.

14. The system of claim 13, further comprising one or more additional central processing units.

15. The system of claim 9, wherein the second processing element is a graphics processing unit.

16. The system of claim 15, wherein the graphics processing unit is to execute multiple threads concurrently.

17. The system of claim 11, wherein said
said determining further comprises determining, based on execution time projections T′_{G}(N) for the first processing element and T′_{G}(N) for the second processing element, a value β for problem size Nᵣ to minimize Max((p/p−x)T′_{C}(βNᵣ), T′_{G}((1−β)Nᵣ));
wherein p is a number of cores of a first of the processing element that are available to perform portion β of said work and x is a number of cores of said first processing element that is to be reserved for handshaking with a second of said processing elements.

18. A computer program product, comprising a computer usable medium having a computer readable program code embodied therein, said computer readable program code adapted to be executed to implement a method, said method comprising:
determining a mapping of work among heterogeneous processing elements during dynamic compilation of a user program;
wherein said determining is based on linear equations that approximate the time to execute a portion of said work on each processing element; and
mapping at least a portion of said work to a first of said processing elements.

19. The product of claim 18, wherein:
said linear equations have been derived from curve-fitting based on empirical runt-time data.

20. The product of claim 18, further comprising:
mapping a second portion of said work to a second of said processing elements.

21. The product of claim 18, further comprising:
determining a current input problem size for said work.

22. The product of Claim I, further comprising:
determining a number of cores of said first processing element that are available for execution of said work.

23. The product of claim 1, further comprising:
determining a number of cores of said first processing element to assign for handshaking with a second of said processing elements.

24. The product of claim 1, wherein:
said determining further comprises determining, based on execution time projections T′_{G}(N) for the first processing element and T′_{G}(N) for the second processing element, a value β for problem size Nᵣ to minimize Max((p/p−x)T′_{C}(βNᵣ), T′_{G}((1−β)Nᵣ));
wherein p is a number of cores of a first of the processing element that are available to perform portion β of said work and x is a number of cores of said first processing element that are to be reserved for handshaking with a second of said processing elements.

25. The product of claim 24, further comprising:
mapping all of said work to said first processing element responsive to determining β≦0.

26. The product of claim 24, further comprising:
mapping all of said work to said first processing element responsive to determining β≧1.

27. The product of claim 24, further comprising:
mapping a second portion of said work to a second of said processing elements responsive to determining 0<β<1.
